(19) United States
(12) Patent Application Publication
(10) Pub. No.: US 2008/0285003 A1
(43) Pub. Date: Nov. 20, 2008

(54) Linear motor driven automatic reticle blind

(75) Inventors: Michael B. Binnard, Belmont, CA (US); Douglas C. Watson, Campbell, CA (US); Yoichi Arai, Honjo-shi (JP)

Correspondence Address: Roeder & Broder LLP, 5560 Chelsea Avenue, La Jolla, CA, 92037, US

(73) Assignee: Nikon Corporation, Tokyo (JP)

(21) Appl. No.: 11/803,595

(22) Filed: May 15, 2007

(51) Int. Cl. G03B 27/42

(52) U.S. Cl. 355/71

(57) ABSTRACT

A reticle blind which is capable of being opened and closed at a relatively high speed and which does not cause mechanical disturbances or reaction forces. The reticle blind includes two reticle blind assemblies designed to cooperate with one another to control the passing of a laser beam of an exposure system onto a work piece, such as a semiconductor wafer or flat panel display. Each reticle blind assembly includes a linear motor having a mover and a blind configured to be positioned between a first position and a second position by the mover. Each reticle blind assembly also includes a counter mass assembly including a portion of a guide mechanism having at least one guide bar and a stator of the linear motor. The stator of the linear motor and the guide bar are integrated to form the counter mass which is configured to absorb reaction forces that are created when the blind is moved. In various embodiments, the blinds can be configured to operate in the vertical or horizontal orientation.

### BACKGROUND OF THE INVENTION

### Field of Invention

The present invention relates generally to shielding reticles in lithographic systems. More particularly, the present invention relates to a blind which may be opened and closed as needed to control the projection of a laser beam through a reticle of a lithography tool.

Lithography machines operate by passing light, typically generated by a laser, through the reticle. An optical projection system then projects the pattern onto the wafer. To prevent the laser beam from passing through the reticle onto the incorrect location on the wafer, reticle blinds are often used to shield the reticle from the laser until the wafer is properly positioned. Reticle blinds, which are typically used in a horizontal orientation, can be configured to operate at high speeds. At relatively high speeds, however, the blinds can cause mechanical disturbances and reaction forces, which may again cause a compromise in the integrity of the exposure process. Furthermore, the horizontal configuration often requires undesired compromises in the optical design of the lithographic system.

Therefore, a reticle blind which is capable of being opened and closed at a relatively high speed, which does not cause mechanical disturbances or reaction forces, and which operates in a vertical orientation is needed.

### SUMMARY OF THE INVENTION

The present invention relates to a reticle blind which is capable of being opened and closed at a relatively high speed and which does not cause mechanical disturbances or reaction forces. The reticle blind includes two reticle blind assemblies designed to cooperate with one another to control the passing of a laser beam of an exposure system onto a work piece, such as a semiconductor wafer or flat panel display. Each reticle blind assembly includes a linear motor having a mover and a blind configured to be positioned between a first position and a second position by the mover. Each reticle blind assembly also includes a counter mass assembly including a portion of a guide mechanism having at least one guide bar and a stator of the linear motor. The stator of the linear motor and the guide bar are integrated to form the counter mass which is configured to absorb reaction forces that are created when the blind is moved. In various embodiments, the blinds can be configured to operate in the vertical or horizontal orientation.

### BRIEF DESCRIPTION OF THE DRAWINGS

The invention may best be understood by reference to the following description taken in conjunction with the accompanying drawings in which:

FIGS. 1A and 1B are block diagrams of a lithography tool which allows a laser beam to be projected through a reticle to project a pattern onto a wafer in accordance with the present invention.

FIGS. 2A and 2B are block diagram representations of a lithography tool in which a horizontal and vertical automatic reticle blind is positioned in accordance with two embodiments of the present invention.

FIGS. 3A through 3E is a sequence of diagrams illustrating the operation of two half reticle blinds used in the lithography tool of the present invention.

FIGS. 4A through 4D are various diagrams of a half blind assembly in accordance with a first embodiment of the present invention.

FIGS. 5A through 5D are various diagrams of a half blind assembly in accordance with a second embodiment of the present invention.

FIGS. 6A through 6D are various diagrams of a half blind assembly in accordance with a third embodiment of the present invention.

FIG. 7A is a diagrammatic representation of a counter mass with an anti-gravity device that is a pressurized air piston in accordance with an embodiment of the present invention.

FIG. 7B is a diagrammatic representation of a counter mass with an anti-gravity device that is a vacuum air piston in accordance with an embodiment of the present invention.

FIG. 7C is a diagrammatic representation of a counter mass with an anti-gravity device that is a spring in accordance with an embodiment of the present invention.

FIG. 7D is a diagrammatic representation with an anti-gravity device that is an actuator in accordance with an embodiment of the present invention.

FIG. 8 is a diagrammatic representation of a photolithography apparatus in accordance with an embodiment of the present invention.

FIG. 9 is a process flow diagram illustrating the steps associated with fabricating a semiconductor device in accordance with an embodiment of the present invention.

FIG. 10 is a process flow diagram illustrating the steps associated with processing a wafer in accordance with an embodiment of the present invention.

### DETAILED DESCRIPTION OF THE EMBODIMENTS

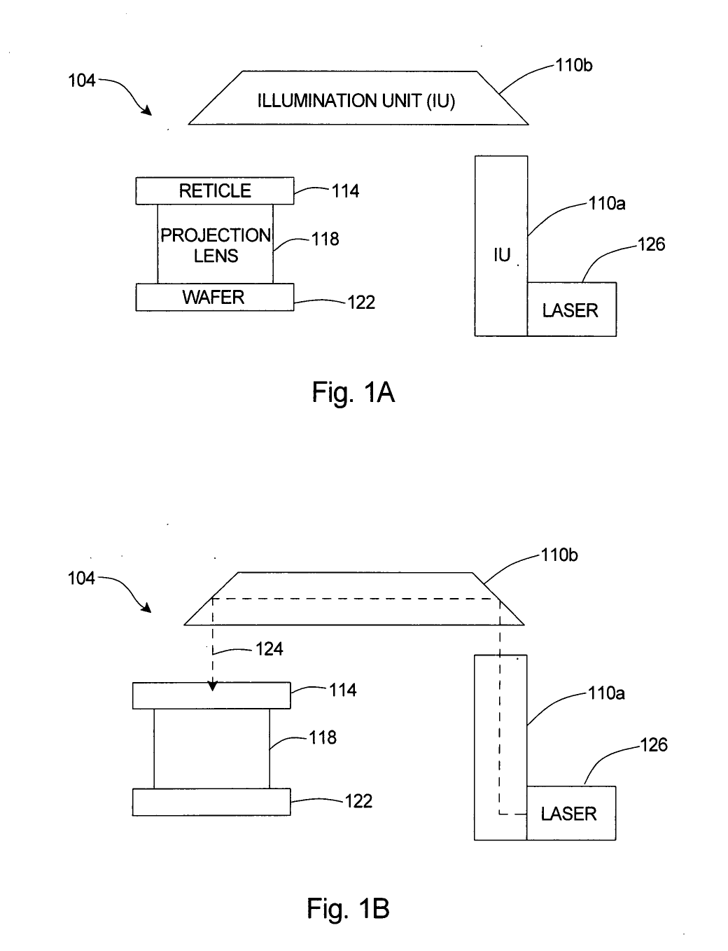

FIG. 1A is a block diagram representation of a system which allows a laser beam to be projected through a reticle to project a pattern onto a wafer in accordance with an embodiment of the present invention. The system 104 includes an illumination unit 110 that includes a first section 110a and a second section 110b. A laser beam generated by a laser or a laser source 126 is arranged to pass through first section 110a, second section 110b, and projected through a reticle 114. A projection lens 118 allows patterns on reticle 114 to be projected onto a surface of a wafer 122 when a laser beam passes through reticle 114. As will be understood by those skilled in the art, reticle 114 is typically supported on a reticle stage (not shown), while wafer 122 is typically supported on a wafer stage (not shown). For ease of illustration, the reticle stage and wafer stage are not shown.

Referring next to FIG. 1B, the path of a laser beam 124 from laser source 126 to reticle 114 is described in accordance with an embodiment of the present invention. The laser beam 124 is generated by laser source 126. The beam 124 is reflected off various mirrored surfaces (not shown) within the first portion 110a and second portion 110b of illumination unit 110. Within second portion 110b, laser beam 124 is reflected approximately 90 degree angles at two different points to enable laser beam 124 to follow a path that passes through reticle 114.

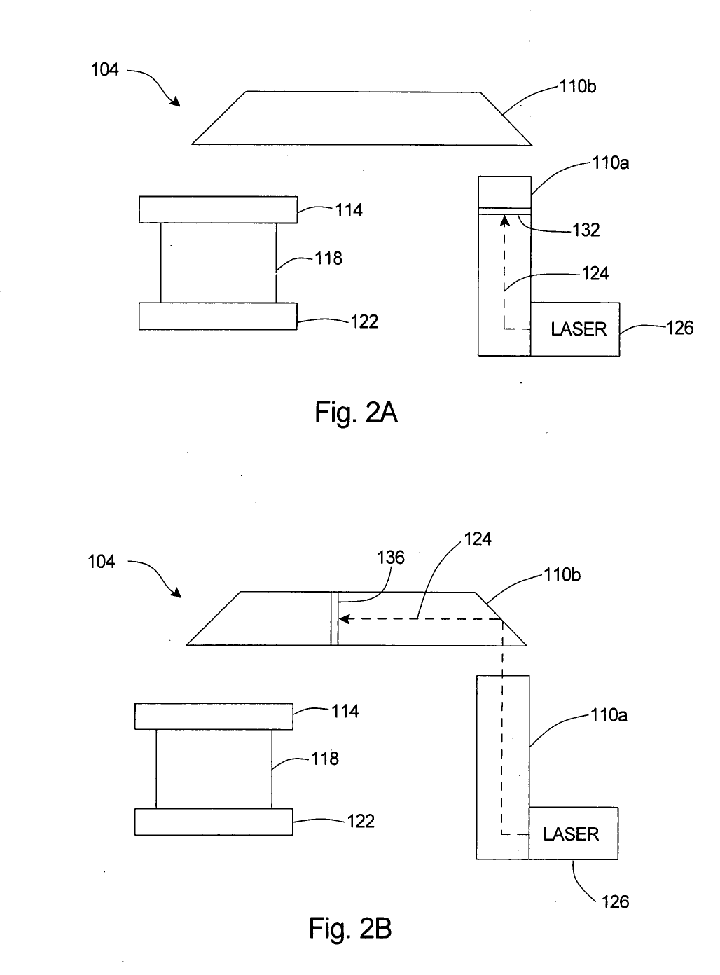

To protect wafer 122 from being exposed to laser beam 124 before an appropriate time, e.g., before the portion of wafer 122 to be exposed is situated in the path of laser beam 124, an automatic reticle blind is used to shield reticle 114 and, hence, wafer 122 from laser beam 124. An automatic reticle blind may be positioned horizontally, as for example within first portion 110a of illumination unit 110, or vertically, as for example within second portion 110b of illumination unit 110. FIG. 2A is a diagrammatic representation of a horizontal automatic reticle blind positioned in first portion 110a of illumination unit 110. In system 104, a reticle blind 132 is positioned within first portion 110a. When in a closed or shut configuration, as shown, reticle blind 132 is arranged to prevent laser beam 124 from passing through reticle blind 132. The path for the laser beam 124 to reach reticle 114 is therefore effectively obstructed by reticle blind 132. When reticle blind 132 is in an open configuration, the laser beam 124 passes through an opening in reticle blind 132 to reticle 114.

With reference to FIG. 2B, a vertical reticle in accordance with another embodiment of the present invention is shown. With this embodiment, the reticle blind moves in the vertical direction. The vertical reticle blind 136 is arranged in second portion 110b of illumination unit 110. When in a closed configuration, the vertical reticle blind 136 obstructs laser beam 124, preventing laser beam 124 from passing through second portion 110b to reticle 114. The vertical reticle blind 136, as illustrated, is in the closed position: As such, the blind 136 is arranged to block the path of laser beam 124 before laser beam 124 “turns” ninety degrees within second portion 110b towards reticle 114. When in the open position, vertical reticle blind 136 allows laser beam 124 to pass through second portion 110b to reticle 114.

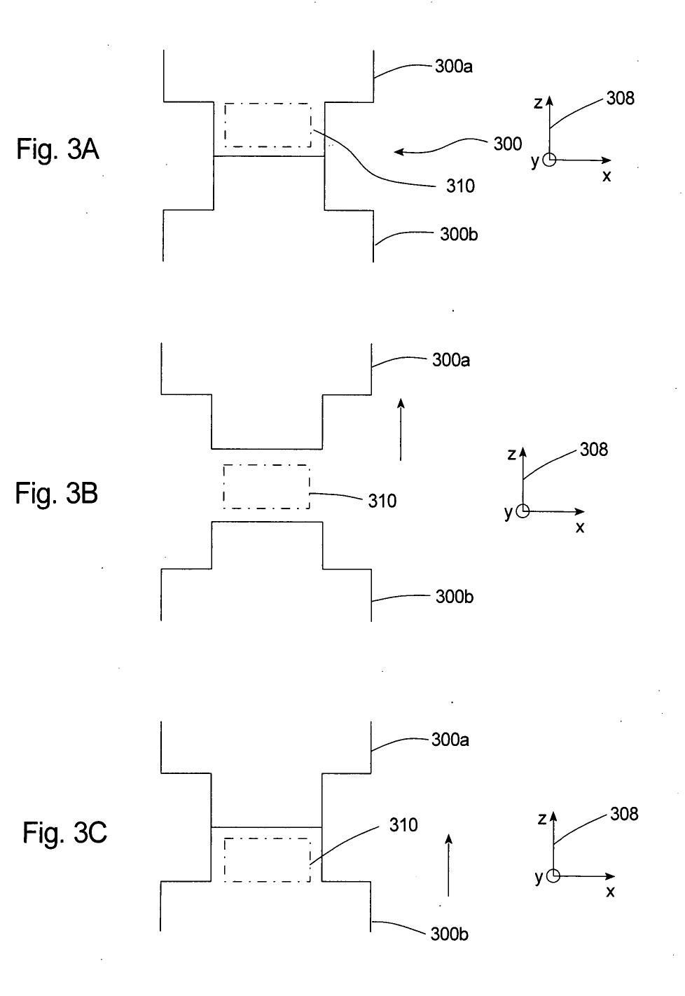

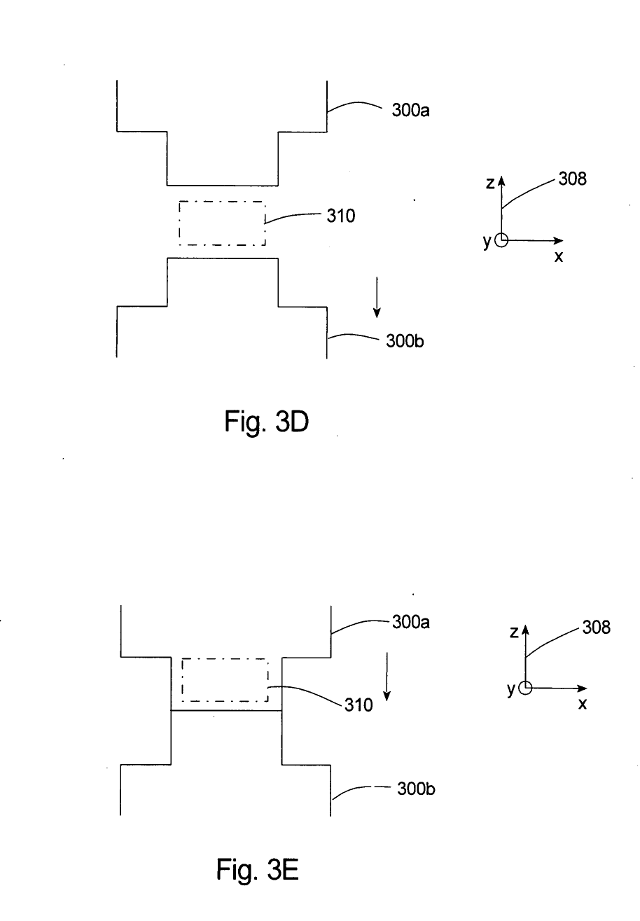

Referring to FIGS. 3A through 3E, a method of operating an automatic reticle blind 300 will be described in accordance with an embodiment of the present invention. The reticle blind 300 includes a first blind half 300a and a second blind half 300b. While reticle blind 300 is shown as being in the vertical orientation (i.e., the first blind half 300a and second blind half 300b are both arranged to move in directions along a Z-axis 308, it should be appreciated that reticle blind 300 may instead be horizontally oriented with the two blind halves 300a and 300b moving along the X-axis or Y-axis).

Reticle blind 300, when in a closed position as shown in FIG. 3A, is arranged to shield an exposure area 310. First blind half 300a and second blind half 300b each include an area that is arranged to shield exposure area 310. The laser beam is therefore blocked from exposing the wafer.

As the wafer and reticle move into the proper position, the exposure area 310 on the wafer is exposed by moving first blind half 300a in a direction along z-axis 308 away from second blind half 300b, as shown in FIG. 3B. The movement of first blind half 300a effectively opens a slit between first blind half 300a and second blind half 300b, exposing the underlying wafer. When first blind half 300a is moved away from second blind half 300b, the exposure process involving exposure area 310 may be performed. As is well understood by those skilled in the art, the movement of first blind half 300a must be precisely synchronized with the motion of the reticle and wafer stages.

As the exposure process is completed with respect to exposure area 310, exposure area 310 is once again needs to be shielded from the laser beam. To shield exposure area 310, second blind half 300b is moved upward along the Z-axis 308 so that the second blind half 300b shields exposure area 310. FIG. 3C shows exposure area 310 being shielded by second blind half 300b. Again, the motion of second blind half 300b must by synchronized with the motion of the reticle and wafer stages.

As the wafer and reticle are positioned and ready to be exposed again, the second blind half 300b is moved downward along z-axis 308 away from first blind half 300a, as illustrated in FIG. 3D. As second blind half 300b is moved, the exposure area 310 is opened.

As the exposure process is completed, the first blind half 300a is moved downward along the Z-axis 308 toward second blind half 300b to shield exposure area 310, as shown in FIG. 3E. In this position, the laser is blocked, no longer allowing the wafer to be exposed.

The above-described steps as illustrated in FIGS. 3A through 3E are continuously repeated until the entire wafer is exposed.

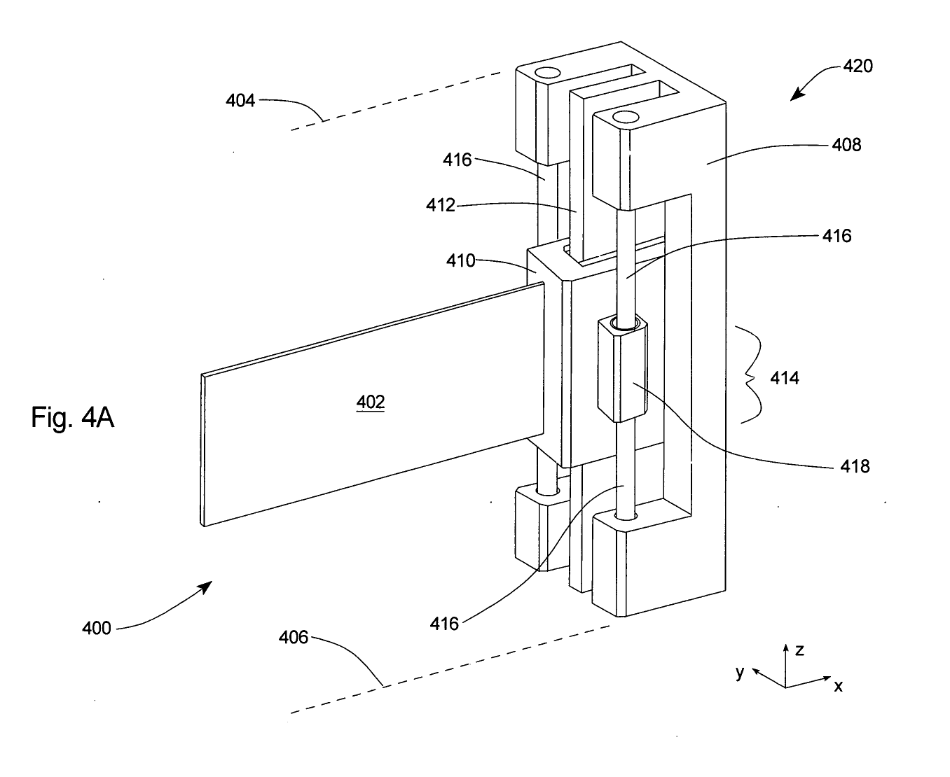

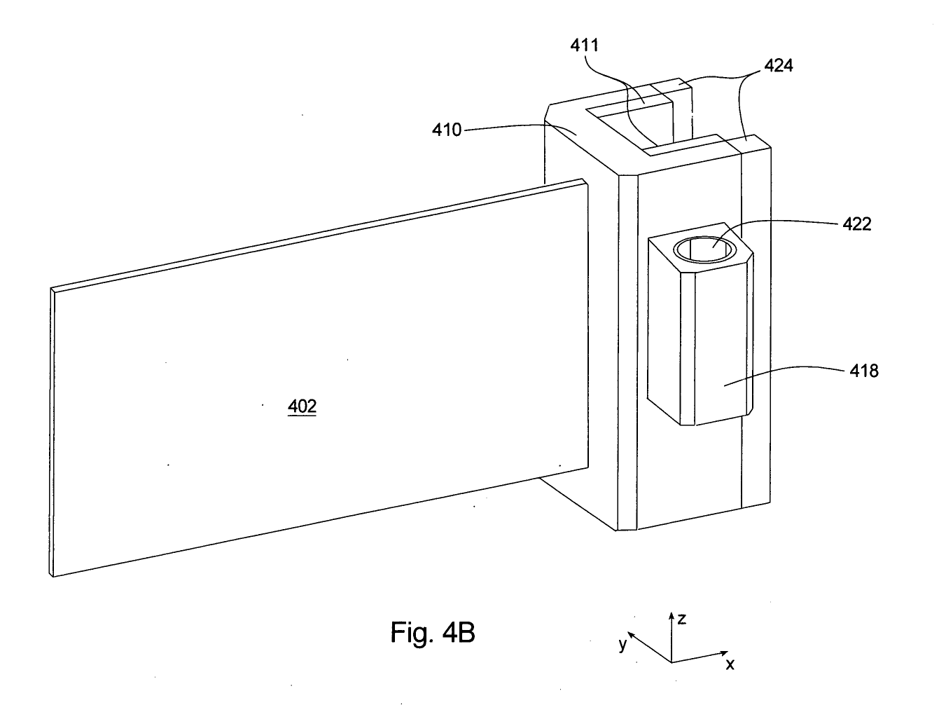

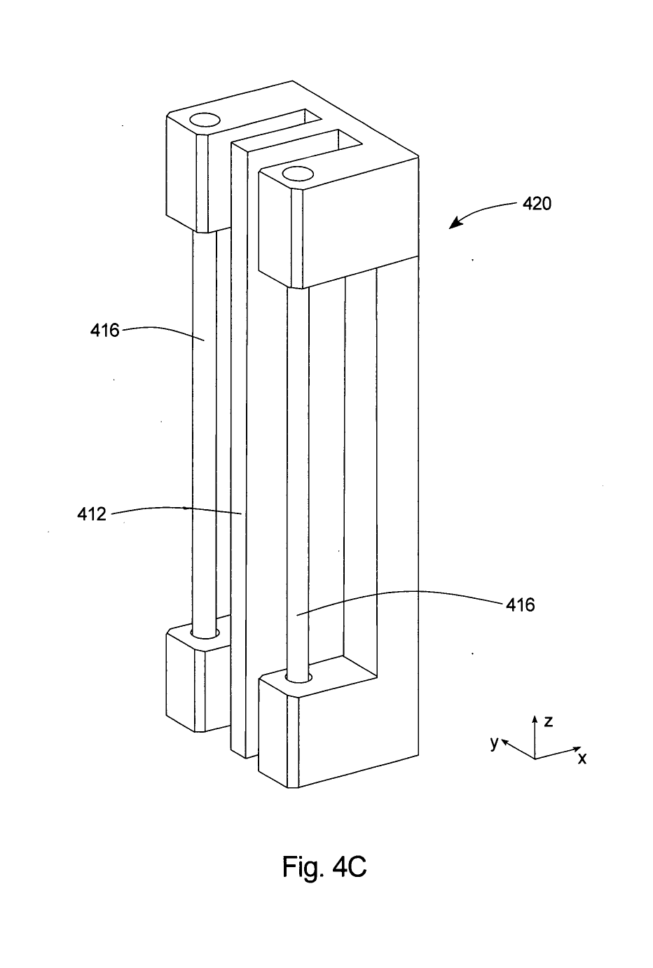

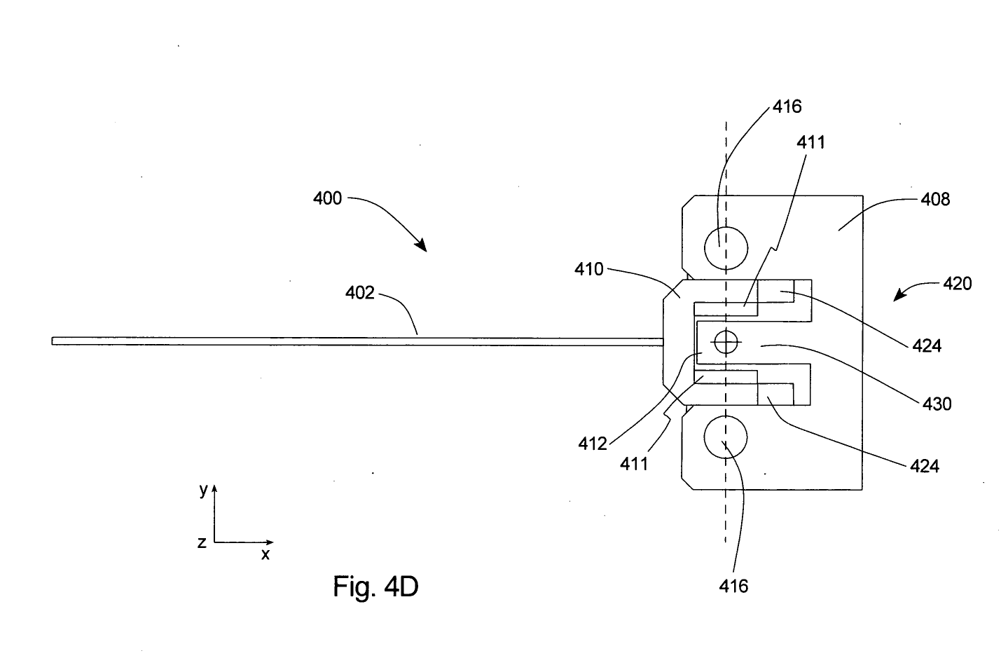

Referring to FIG. 4A through 4D, various views of a half blind assembly 400 according to the present invention are shown.

In FIG. 4A, a perspective view of the half blind 400 is shown. The blind assembly 400 includes a blind 402 arranged to move between a first position 404 and a second position 406, a linear motor 408 including a mover 410 and a stator 412, a guide mechanism 414 including guide bars 416 and bushings 418, and a counter-mass assembly 420 including the stator 412 and the guide bars 416.

Referring to FIG. 4B, a perspective view of a blind assembly 401, comprising the blind 402, mover 410, and bushings 418 is shown. As illustrated, the blind 402 extends outward from a first surface of the mover 410. The mover 410 includes magnet arrays 411 that extend up and down the length of the mover 410. One bushing 418 is attached to a second surface of the mover 410. The other bushing 418, not visible in the figure, is attached to the opposite third surface of the mover 410. Each of the bushings 418 includes a receptacle 422 designed to receive the guide bars 416 respectively. In various embodiments, weights 424 may be attached to fourth surfaces of the mover 410. The weights 424 are optionally provided to control the location-of the center of gravity (CG) of the blind assembly.

Referring to FIG. 4C, a perspective view of just the counter-mass assembly 420, comprising stator 412 and guide bars 416 is shown. An array of coils (not visible) is provided inside the stator 412. Stator 412 and mover 410 cooperate to form a linear motor for moving the blind assembly 401 relative to counter-mass assembly 420.

Referring to FIG. 4D, a top down view of the half blind assembly 400 is shown. As is evident iii this figure, the blind 402 extends outward from the mover 410 of the linear motor 408. The mover 410 is designed to move along the length of the stator 412. The counter-mass 420 (i.e., the stator 412 and the guide members 416) absorbs the reaction forces created when the blind 402 is moved between the first 404 and second 406 positions. The mover 410 defines a push-point, which is the location of the net force. In this embodiment, the mover push-point is preferably aligned with the center of gravity (CG) 430 of the blind assembly 401. As evident in FIG. 4D, the blind assembly 401 has a center of gravity 430 that is aligned (with respect to the Z axis) with the push-point of the mover 410. Preferably, the center of gravity for the colinter-mass 420 is also aligned with the center of gravity 430. In some embodiments, the guide bars 416 are symmetrically arranged en two sides of the center of gravity 430.

During operation, electric current is applied to the array of coils provided within the stator 412. The current in the array of coils interacts with the magnetic field of the magnets 411 in the mover 410, creating a force. The force causes the blind assembly 401 to travel along the stator 412 between the first and second positions 404 and 406. Thus, by controlling the current, which in turn controls the force, the position of the blind 402 can be precisely controlled. When the blind assembly 401 is moved, the bushings 418 guide the movement of the mover 410 along the guide bars 416.

The half blind 400 is designed to cooperate with a complimentary second half blind 400. The two half blinds 400 operate as described above with regard to FIGS. 3A through 3E. In one embodiment, the two half blinds 400 are oriented in the horizontal plane and the two blinds 402 are designed to move between the first 404 and second 406 positions along the X-axis respectively. In an alternative embodiment, the two half blinds 400 are oriented in the vertical plane and their respective blinds 402 move up and down between the first 404 and second 406 positions along the Z-axis. The two half blinds 400 can be configured with independent counter-mass assemblies 420. Alternatively, the blind assemblies 401 of the two half binds 400 can both share a single counter-mass 420. In this configuration, both blind assemblies 401 travel along the same guide bars 416, and are driven by linear motors comprising the same stator 412.

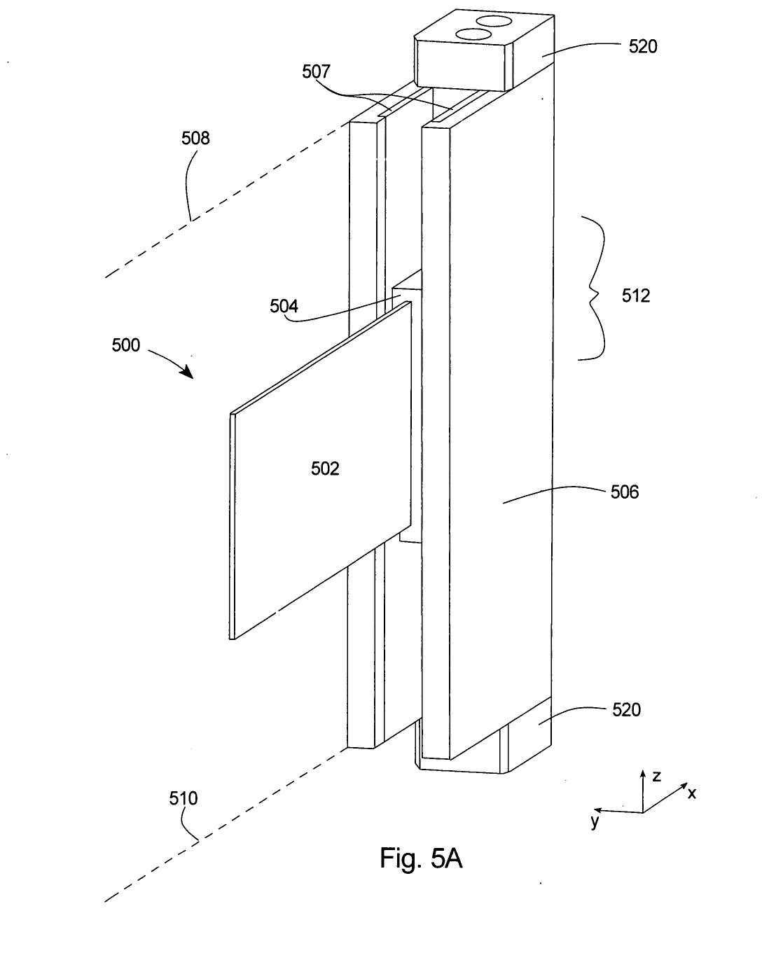

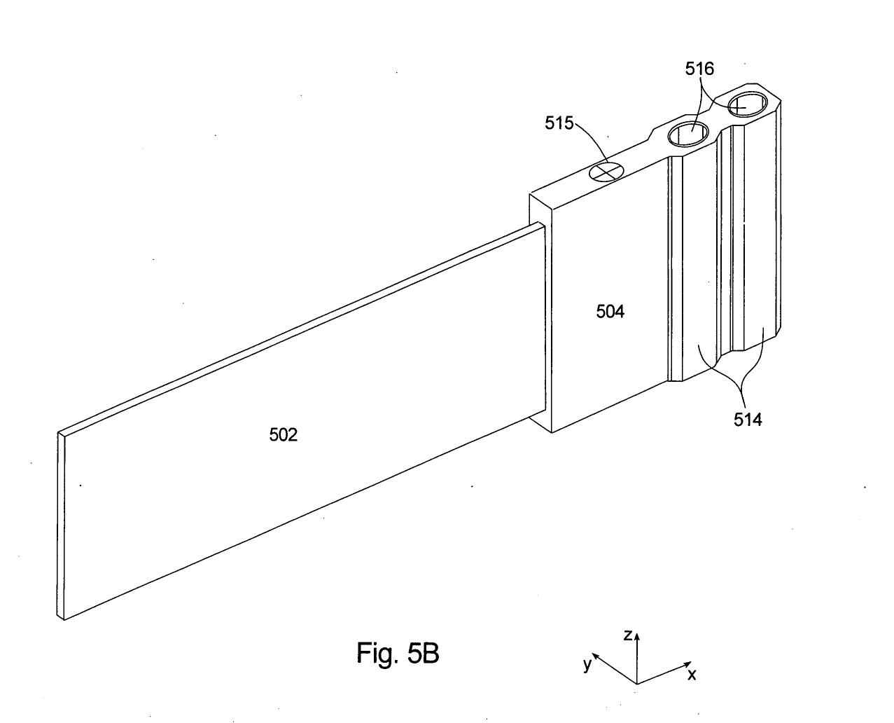

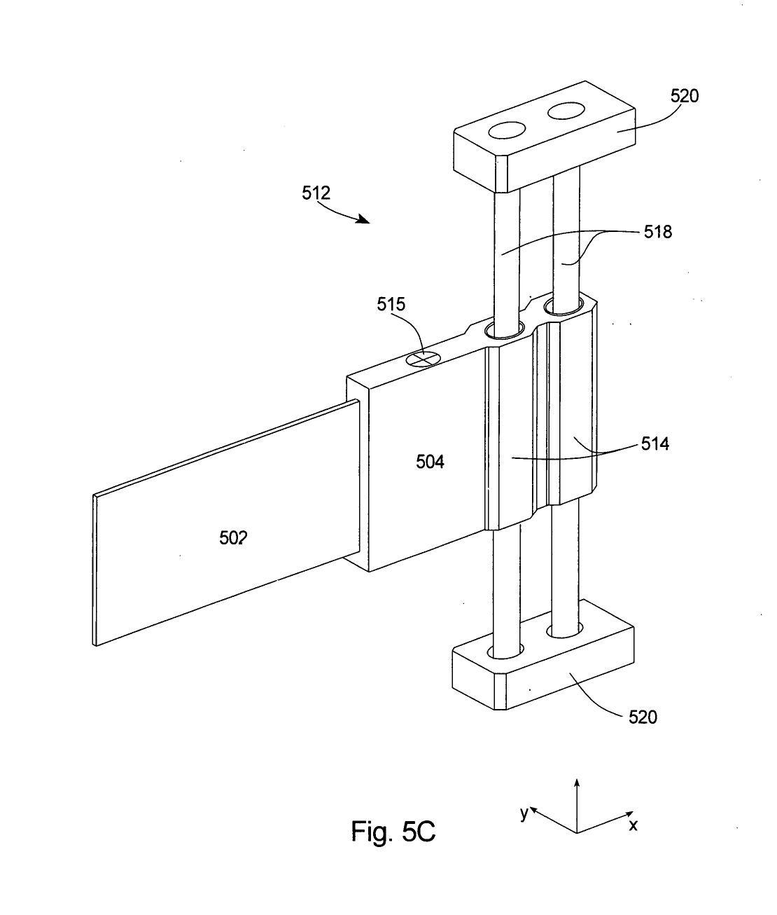

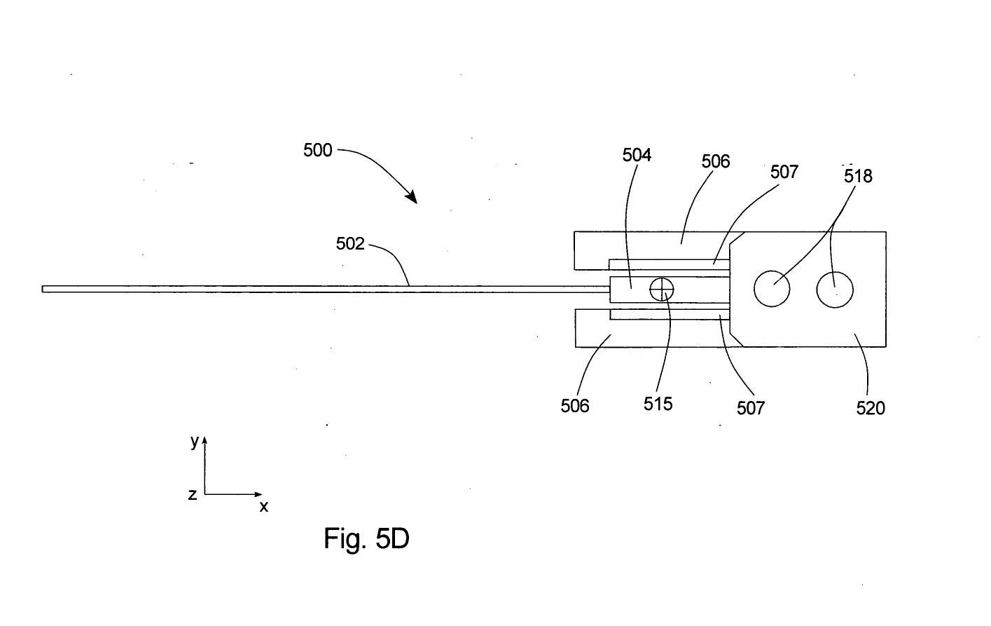

Referring to FIGS. 5A through 5D, various views of another half blind assembly 500 according to a second embodiment of the invention are shown.

Referring to FIG. 5A, a perspective view of the half blind 500 is shown. The half blind 500 includes a blind 502 attached to a mover 504 contained within a stator 506. The stator includes magnet arrays 507. The half blind 502 is designed to move between a first position 508 and a second position 510. The half blind 500 also includes a guide mechanism 512 that includes end support members 520 and guide bars and bushings, both of which are not visible in this figure.

Referring to FIG. 5B, a perspective view of blind assembly 501, comprising the blind 502, the mover 504, and bushings 514 is shown. In this view, the blind 502 is extending outward from one surface of the mover 504. Two bushings 514 are attached to an opposing second surface of the mover 504. Each bushing 514 includes a recess 516 to receive a guide bar (not shown). The center of gravity of the blind assembly 501 is designated by reference number 515.

Referring to FIG. 5C, a perspective view of the blind 502, mover 504 and the guide mechanism 512 is shown. In this figure, the stator 506 has been removed to illustrate how the blind 502 and mover 504 are guided by the guide mechanism 512. The guide mechanism 512 includes two guide bars 518 positioned between end members 520. The end support members 520 maintain the two guide bars in a rigid, parallel relationship with one another. Each guide bar 518 passes through the recess 516 of the bushings 514 respectively.

Referring to FIG. 5D, a top-down view of the half-blind assembly 500 is shown. As depicted, the blind 502 extends outward from the mover 504. The mover 504 is designed to move along the length of the stator 506 as guided by the guide bars 518 of the guide mechanism 512. Mover 504 and stator 506 cooperate to form a linear motor. With the arrangement shown, center of gravity 515 of blind assembly 501 is aligned with the push-point of the linear motor. In this way, there is substantially zero moment acting on the blind assembly 501, so bushings 514 to move up and down the guide bars 518 with minimal resistance.

During operation, electric current is applied to the array of coils 507 provided in the stator 506. The current in the array coils 507 interacts with the magnetic field of the magnets provided within the mover 504, creating a force. The force causes the blind assembly 501 to travel along the stator 506. By controlling the current applied to the array of coils 507, the position of the blind and mover can be precisely controlled between the first position 508 and the second position 510.

The half blind 500 is designed to cooperate with a complimentary second half blind 500. The two half blinds 500 operate as described above with regard to FIGS. 3A through 3E. In alternative embodiments, the two half blinds 500 can be oriented in either the horizontal or vertical configuration with the blinds 502 moving in either the X or Z planes respectively. As with the other embodiments, the two half blinds 500 can share the same counter-mass assembly 522, or two separate counter-mass assemblies.

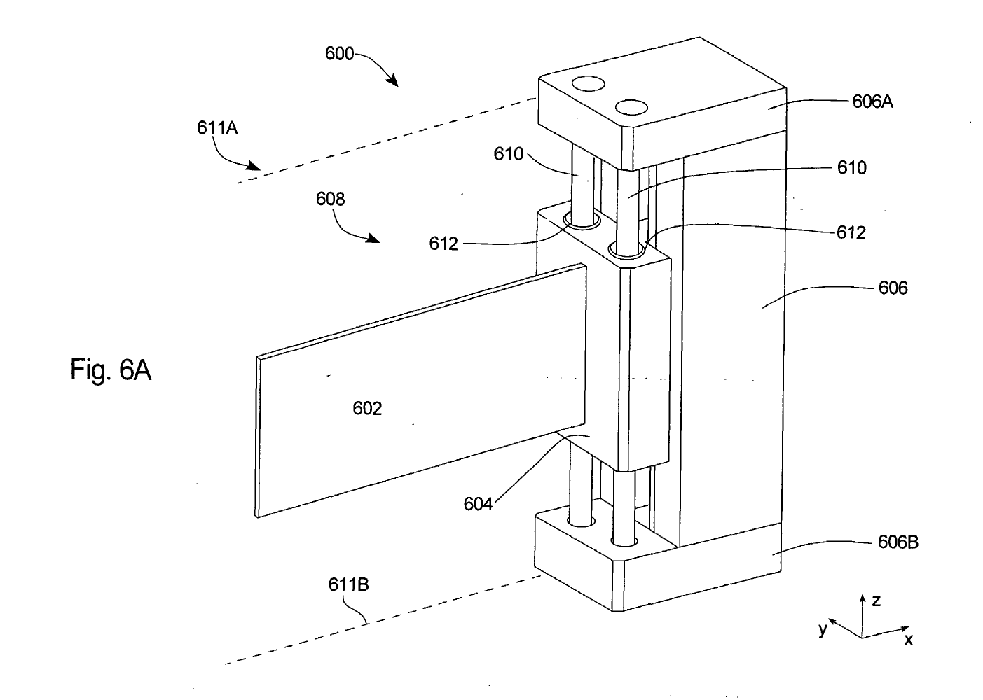

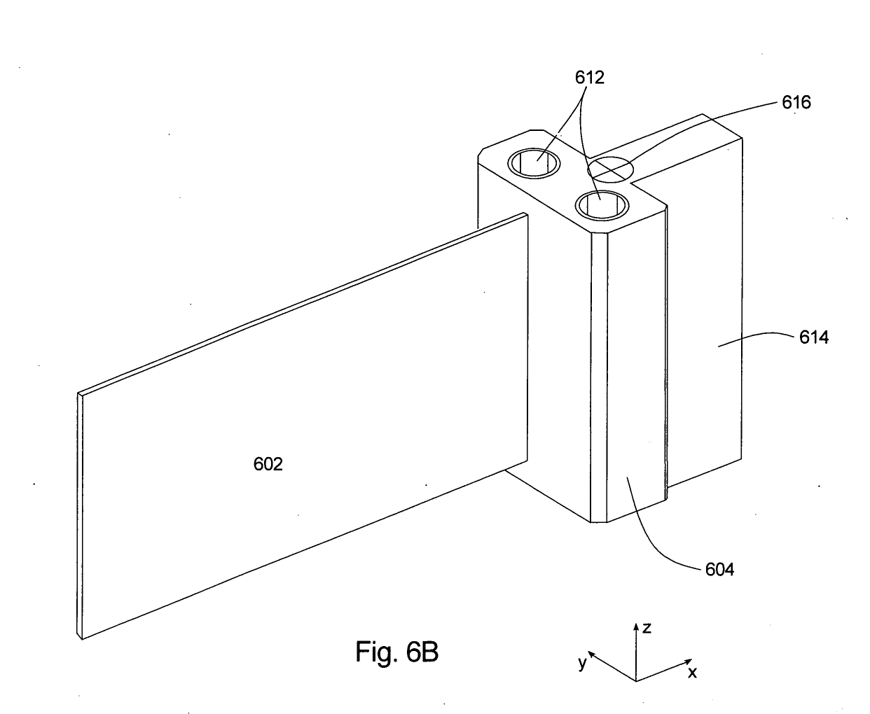

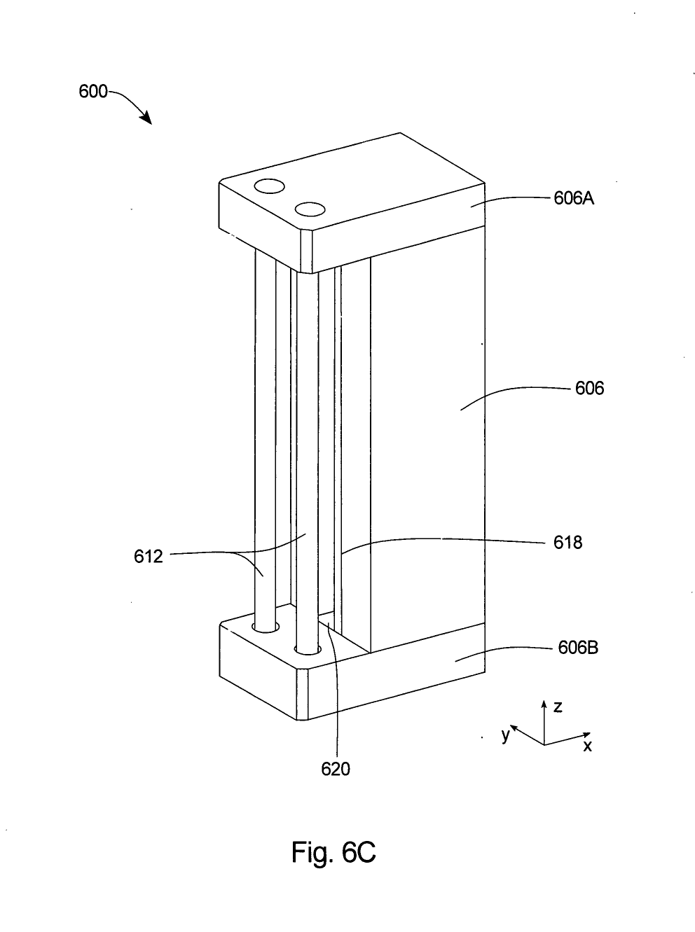

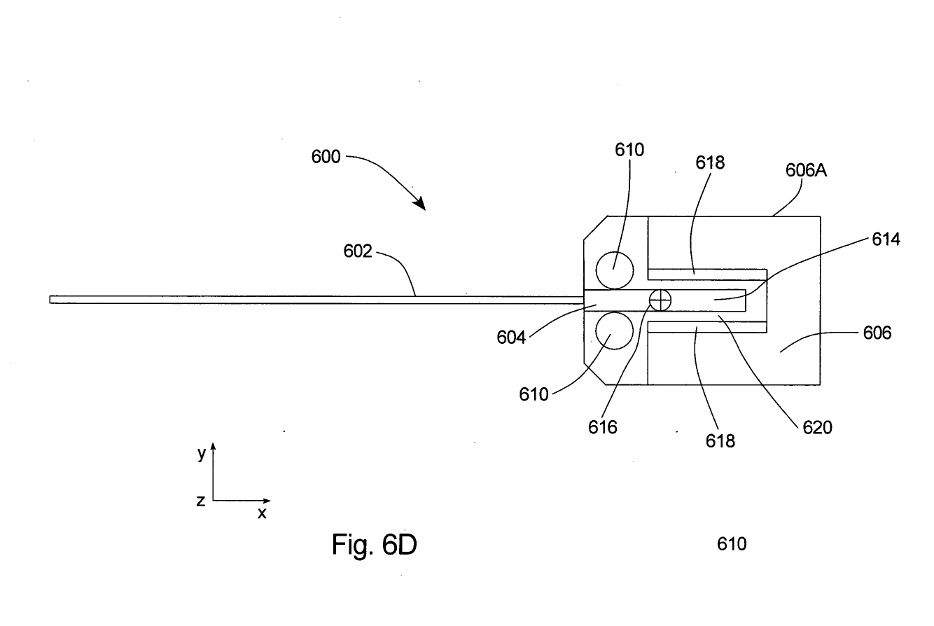

Referring to FIGS. 6A through 6D, various views of yet another half blind assembly 600 according to a third embodiment of the invention are shown.

Referring to FIG. 6A, a perspective view of the half blind assembly 600 is shown. The half blind 600 includes a blind 602 attached to a structural member 604 of the blind assembly. A stator 606 is connected between two support structures 606A and 606B. A guide mechanism 608, including two guide bars 610, is connected between the two support structures 606A and 606B. The mover 604 includes two bearings 612 that allow the structural member 604 and blind 602 to move along the guide bars 610 between a first position 611A and a second position 611B. Referring to FIG. 6B, a perspective view of just the blind 602, structural member 604 and a mover 614 are shown. As illustrated, the blind 602 extends outward from a first surface of the member 604. A mover 614 is attached to and extends outward from an opposed second surface of the structural member 604. The stator 606 and the mover 614 cooperate together to create a linear motor. In this embodiment, the CG of the blind assembly 601 is not aligned with the push-point of the linear motor. As a result, the force applied to the mover 614 by the linear motor creates a moment on the blind assembly 601. This moment is canceled by the action of the bearings 612 and the guide bars 610. With this arrangement, the blind 602 and mover 614 can move along the guide bars 610 without rotating, and the moment created by the driving force is transferred into the guide bars 610.

Referring to FIG. 6C, a perspective view of the stator 606 without the blind 602, structural member 604 and mover 614 is shown. In this view, an array of coils 618 is provided within a recess 620 of the stator 606. Another array of coils 618 (not visible) is also provided within the recess 620 opposed to the shown array of coils. The recess 620 is designed to receive the mass 614 of the mover 604 (not shown).

Referring to FIG. 6D, a top down view of the half blind 600 is shown. In this diagram, the blind 602 is shown extending outward from the mover 614. The mass of the mover 614 is positioned within the recess 620 of the stator 606, with the magnet array 618 positioned on both sides of the recess. The blind 602 and mover 614 assembly has a center of gravity 616 in a location that allows the assembly to move along the guide bars 610 without rotating.

During operation, current is applied to the two arrays of coils 618 of the stator 606. The current in the coils interacts with magnets contained within the mover 604, creating a force. The force causes the mover 604 and blind 602 to travel along the stator 606 as guided by the guide bars 610. By controlling the current, which in turn controls the force, the position of the blind 602 can be precisely controlled between the first position 611A and the second position 611B. When the blind 602 and mover 604 are moved, it creates reaction forces. The driving force of the linear motor (mover 604 and stator 606) creates a moment on the blind assembly (blind 602 and mover 604) and the reaction force of the linear motor creates an opposing moment on the counter mass, wherein the moment and the opposing moment substantially cancel each other out. With the embodiment illustrated in FIGS. 6A-6D, the stator 606 and guide bars 610 are connected to form a counter-mass configured to absorb the reaction forces when the blind 602 is moved.

In various embodiments, the magnet arrays described above with regard to the embodiments described in relation to FIGS. 4A-4D, 5A-5D and 6A-6D may be either permanent or electromagnet arrays. Furthermore, the linear motors can be replaced with stepper motors or other suitable linear actuators.

According to other embodiments, a support assembly may be needed to compensate for the force of gravity on the counter mass assemblies described above. The configuration of an anti-gravity device may vary widely. A few embodiments according to the present invention are discussed below.

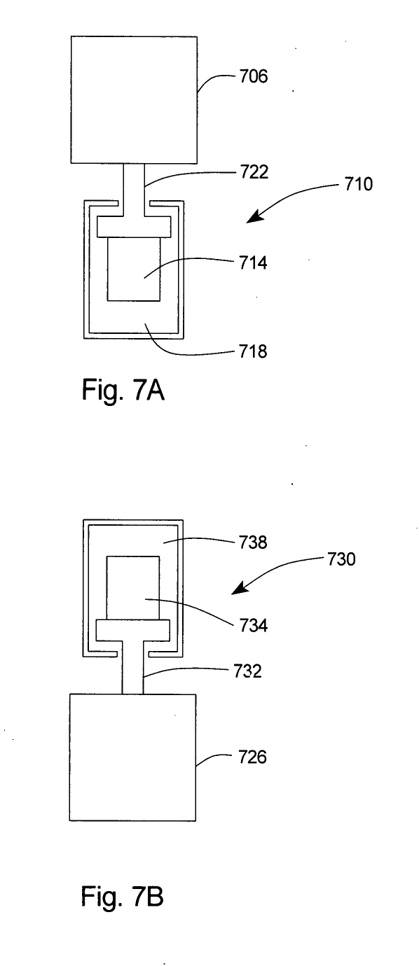

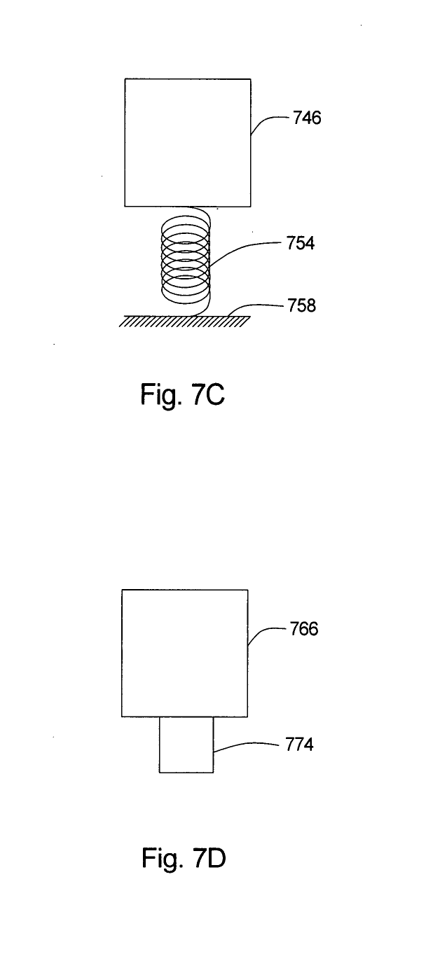

Referring to FIG. 7A, a first embodiment of a counter mass 706 with an anti-gravity device is shown. An air piston 710 provides anti-gravity capabilities to support counter mass 706. Air piston 710 includes a pressurized air chamber 718 in which a piston member 722 is arranged. An actuator 714, which may be a voice coil motor, provides correction forces that allow piston member 722 to effectively support counter mass 706 against forces of gravity.

In lieu of using a pressurized air piston to provide anti-gravity capabilities, a vacuum air piston, or an air piston with a vacuum chamber instead of a pressurized air chamber, may be used. FIG. 7B is a diagrammatic representation of a counter mass 726 with an anti-gravity device that is a vacuum air piston in accordance with an embodiment of the present invention. A vacuum piston 730 is arranged over the counter mass 726. A vacuum applied within a vacuum chamber 738 of vacuum piston 730 effectively holds a piston member 732 in place. The counter mass 726 is mounted onto the piston member 732. An actuator 734, which is positioned within vacuum piston 730, provides a correction force.

In another embodiment, a mechanical spring may be used as an anti-gravity device that supports a counter mass 746. As shown in FIG. 7C, a spring 754 is coupled between a counter mass 746 and a substantially fixed surface 758. In one embodiment, the fixed surface 758 may be an interior wall of an illumination unit. The stiffness of spring 754 may be varied depending upon the size and the mass of counter mass 746. A motor may also be used to support a counter mass.

FIG. 7D is a diagrammatic representation of a counter mass 766 that is supported by a motor 774. As motor 774 may generate a fair amount of heat, the use of motor 774 may be more suitable when counter mass 766 is relatively small. When counter mass 766 is relatively small, the amount of force and, hence, the amount of heat generated by motor 774 may be relatively low.

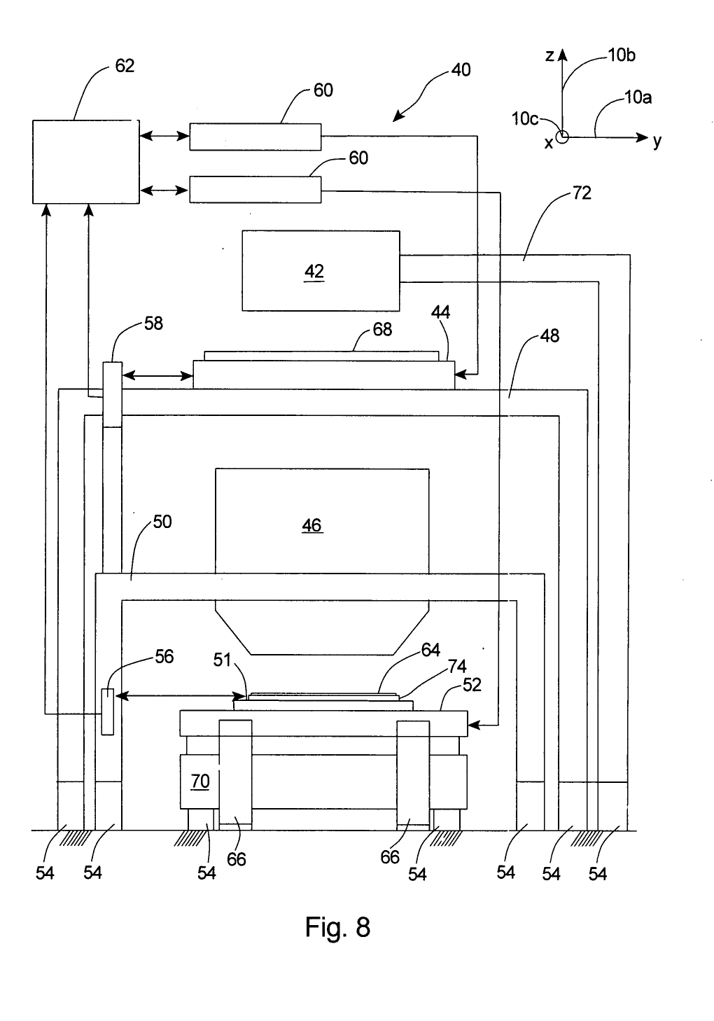

Referring next to FIG. 8, a photolithography apparatus which may utilize an automatic reticle blind will be described in accordance with an embodiment of the present invention. A photolithography apparatus (exposure apparatus) 40 includes a wafer positioning stage 52 that may be driven by linear or planar motors (not shown), as well as a wafer table 51 that is magnetically and/or mechanically coupled to wafer positioning stage 52. The motor which drives or motors which drive wafer positioning stage 52 generally utilize an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between two to six degrees of freedom, under the control of a control unit 60 and a system controller 62. In one embodiment, wafer positioning stage 52 may include a plurality of actuators which are coupled to a common stator track. The movement of wafer positioning stage 52 allows wafer 64 to be positioned at a desired position and orientation relative to a projection optical system 46.

Wafer table 51 may be levitated in a z-direction 10b by any number of VCMs (not shown), e.g., three voice coil motors. In one embodiment, at least three magnetic bearings (not shown) couple and move wafer table 51 along an x-axis 10c and a y-axis 10a. The motor array of wafer positioning stage 52 is typically supported by a base 70. Base 70 may be supported to a ground via isolators 54, or may be supported directly on the ground. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42, in which an automatic reticle blind may be positioned, is supported by a frame 72. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 mn), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent. Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. Patents are incorporated herein by reference in their entireties. A multiple stage exposure apparatus is also described in Japan patent Application Dislosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and an EUVL type exposure apparatus when suitable measures are incorporated to accommodate the vacuum environment for air (fluid) bearing arrangements.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces, i.e., vibrational forces, which are experienced by a stage assembly or, more generally, by a photolithography machine such as photolithography apparatus 40 which includes a stage assembly.

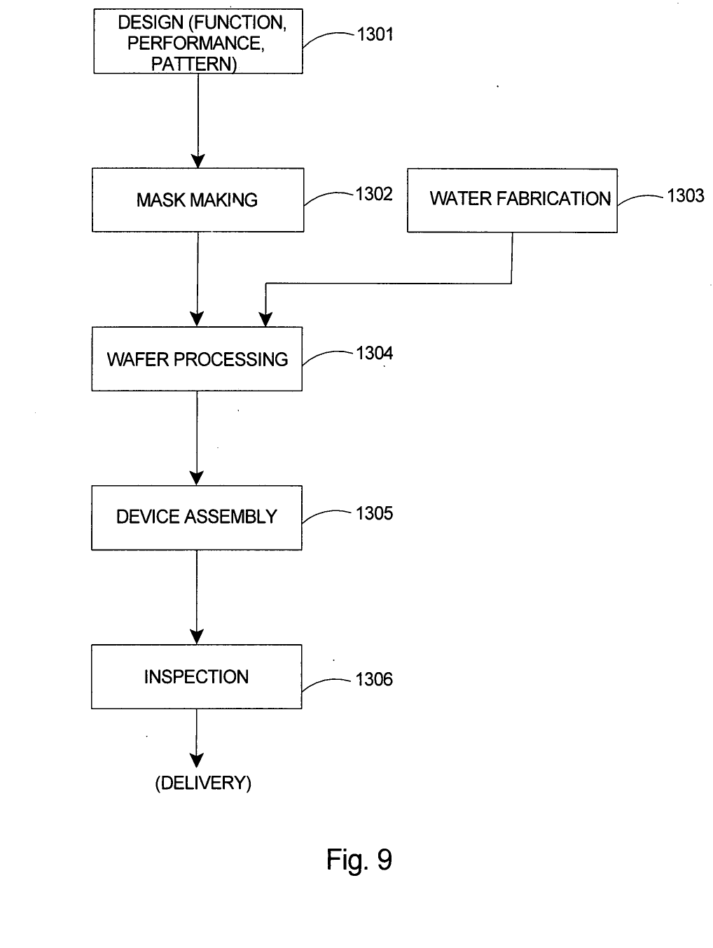

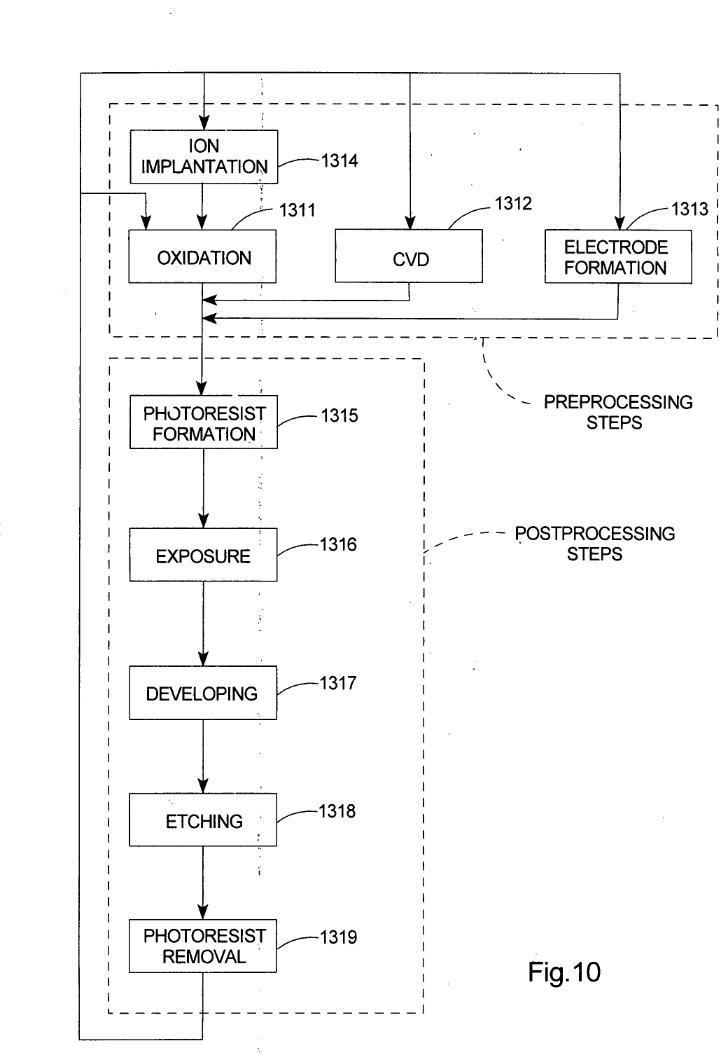

A photolithography system according to the above-described embodiments, e.g., a photolithography apparatus which makes use of an automatic reticle blind such as a horizontal automatic reticle blind or a vertical automatic reticle blind, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled. Further, semiconductor devices may be fabricated using systems described above, as will be discussed with reference to FIG. 9. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 10. In step 1305, the semiconductor device is assembled. The assembly of the semiconductor device generally includes, but is not limited to, wafer dicing processes, bonding processes, and packaging processes. Finally, the completed device is inspected in step 1306.

FIG. 10 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed or the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage. It should be appreciated that when the circuit pattern of the reticle is transferred to the wafer, an automatic reticle blind is generally in an open position to allow a laser beam to pass therethrough.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, one process (described above) of using an automatic reticle blind to shield an exposure area involves moving each half blind independently to open and close the exposure area. . Alternatively, the two half blinds can be spaced apart by the correct distance and moved synchronously together. In this configuration, a larger reticle blind assembly is required, but the construction and operation may be easier.

While a reticle blind may include two portions or halves, a reticle blind may instead include more than two portions. For instance, a reticle blind may include four portions that are each arranged to move. In one embodiment, the use of four portions for a reticle blind may enable the size of an opening or a slit in the reticle blind to be precisely controlled relative to more than one axis.

An air bearing arrangement that is used in a reticle blind assembly has been described as consisting of guide bars and bushings. In one embodiment, openings which allow air to be supplied to an air bearing surface may be incorporated into a moving part of the assembly or into a substantially stationary part of the assembly. It should be appreciated that in the first case as drag, e.g., drag associated with air supply hoses or cables, may be generated when air is supplied through a moving part, measures may need to be taken to reduce the effects of drag. Other bearing configurations which guide the blind assembly to move in substantially one degree of freedom may also be used.

An automatic blind has been described as being used to shield a reticle from a laser. In general, an automatic blind may be used to shield substantially any object. For instance, an automatic blind may be arranged to shield a wafer. Additionally, an automatic blind may shield an object such as a reticle from any light source or otherwise contaminating source.

The steps associated with using an automatic reticle blind may vary widely. Steps may be added, removed, and altered without departing from the spirit or scope of the present invention. For example, a reticle blind that includes two halves may be arranged such that only one half of the reticle blind moves to shield and to unshield an exposure area of a wafer. Therefore, the present examples are to be considered as illustrative and not restrictive, and the invention is not to be limited to the details given herein, but may be modified within the scope of the appended claims.

What is claimed is:

1. An apparatus, comprising:
a blind assembly including:
a blind configured to be moved between a first position and a second position; and
a mover of a linear motor, the mover connected to the blind and configured to move the blind between the first position and the second position; and
a counter mass assembly including:
a portion of a guide mechanism having at least one guide bar; and
a stator of the linear motor,
wherein the stator of the linear motor and the guide bar are integrated to form a counter mass configured to absorb reaction forces that are created when the blind is moved.

2. The apparatus of claim 1, wherein the mover and stator cooperate to form a linear motor capable of producing a force and a corresponding reaction force, wherein the blind assembly and the countermass assembly are driven in opposite directions by the force of the linear motor force the corresponding reaction force.

3. The apparatus of claim 1, wherein the blind is opaque.

4. The apparatus of claim 1, wherein the linear motor is configured to move the blind up and down in a substantially vertical plane.

5. The apparatus of claim 1, wherein the linear motor is configured to move the blind from side to side in a substantially horizontal plane.

6. The apparatus of claim 1, wherein the blind assembly has a first center of gravity and the counter mass has a second center of gravity, wherein the first center of gravity and the second center of gravity are aligned with respect to the direction of motion.

7. The apparatus of claim 6, wherein the guide mechanism having includes two guide bars symmetrically disposed with respect to the first center of gravity and the second center of gravity.

8. The apparatus of claim 6, wherein the guide member is aligned with the first center of gravity of the blind assembly and the second center of gravity of the counter mass.

9. The apparatus of claim 6, wherein the mover of the linear motor defines a push point, the push point being aligned with the first center of gravity of the blind assembly and the second center of gravity of the counter mass assembly, respectively.

10. The apparatus of claim 1, wherein the counter mass assembly further comprises a mass coupled to the linear motor, the size of the mass being selected so that the center of gravity of the counter mass is aligned with the center of gravity of the blind assembly.

11. The apparatus of claim 1, wherein the counter mass assembly further comprises a mass coupled to the linear motor, the size of the mass being selected so that the center of gravity of the counter mass is aligned with the push-point of the linear motor.

12. The apparatus of claim 1, wherein the blind assembly further comprises a mass, the size of the mass being selected so that the center of gravity of the blind assembly is aligned with the center of gravity of the counter mass assembly.

13. The apparatus of claim 1, wherein the blind assembly further comprises a mass, the size of the mass being selected so that the center of gravity of the blind assembly is aligned with the push-point of the linear motor.

14. The apparatus of claim 1, wherein the guide mechanism further comprises bushings connected to the blind assembly.

15. The apparatus of claim 1, wherein the stator is a coil array and the mover is a magnet array.

16. The apparatus of claim 15 wherein the coil array comprises at least one coil.

17. The apparatus of claim 15 wherein the magnet array comprises either a permanent magnet array or an electromagnet array.

18. The apparatus of claim 1, wherein the linear motor is a stepper motor.

19. The apparatus of claim 1, wherein the guide mechanism comprises a pair of guide bars.

20. The apparatus of claim 19 wherein the wherein the blind assembly has a first center of gravity and the counter mass has a second center of gravity aligned with the first center of gravity, and wherein the pair of guide bars of the guide mechanism are symmetrically disposed about the first and the second centers of gravity respectively.

21. The apparatus of claim 1, wherein the linear motor push point is aligned with the centers of gravity of the blind assembly and the counter mass assembly

22. The apparatus of claim 21, wherein the guide member of the guide mechanism includes two shafts that are symmetrically arranged on opposite sides of the linear motor.

23. The apparatus of claim 1, wherein the counter mass assembly has a connecting member that substantially surrounds the guide mechanism and the blind assembly.

24. The apparatus of claim 1, wherein during operation, the driving force of the linear motor creates a moment on the blind assembly and the reaction force of the linear motor creates an opposing moment on the counter mass, wherein the moment and the opposing moment substantially cancel each other out.

25. The apparatus of claim 1, further comprising: an illumination unit.

26. The apparatus of claim 25, further comprising:
a patterning element defining a pattern;
a projection system configured to project the pattern defined by the patterning element onto an object when illuminated by the illumination unit,
wherein the blind selectively controls when the illumination unit is to project the pattern defined by the patterning element onto the wafer by being moved between the first position and the second position.

27. The apparatus of claim 26, wherein the object one of the following: a semiconductor wafer or a flat panel display on a table.

28. The apparatus of claim 25, further comprising a second blind, the blind and the second blind being configured to cooperate to selectively control when the illumination unit is to project the pattern defined by the patterning element onto the wafer

29. The apparatus of claim 27, wherein the two blind assemblies share a common counter-mass assembly.

30. The apparatus of claim 26, further comprising an immersion element configured to maintain immersion fluid in a gap provided between the projection system and the object.
